(19) United States
(12) Patent Application Publication
(10) Pub. No.: US 2026/0011308 A1
(43) Pub. Date: Jan. 8, 2026

(54) PIXEL DRIVING CIRCUIT, CONTROL METHOD THEREFOR AND DISPLAY DEVICE

(71) Applicant: HKC CORPORATION LIMITED, Shenzhen (CN)

(72) Inventors: Zhihao Wang, Shenzhen (CN); Wenqin Zhao, Shenzhen (CN); Wendong Li, Shenzhen (CN); Kang Lv, Shenzhen (CN); Yun Lin, Shenzhen (CN); Lidan Ye, Shenzhen (CN)

(21) Appl. No.: 19/254,015

(22) Filed: Jun. 30, 2025

(30) Foreign Application Priority Data
Jul. 2, 2024 (CN) 202410874751.X

(51) Int. Cl. G09G 3/3233

(52) U.S. Cl. CPC G09G 3/3233; G09G 2300/043; G09G 2300/0819; G09G 2310/08; G09G 2320/0233

(57) ABSTRACT

A pixel driving circuit, a control method for the pixel driving circuit and a display device. The pixel driving circuit is configured to drive a light-emitting element to emit light cross multiple frame cycles, and each frame cycle includes at least a first frame in a timing sequence. The pixel driving circuit includes: a source follower sub-circuit, a driving sub-circuit, a data writing sub-circuit, a compensation sub-circuit, a first reset sub-circuit and a second reset sub-circuit, and a light-emitting control sub-circuit. The pixel driving circuit of the present application utilizes a source follower configuration, which decouples the magnitude of the current flowing through the pixel driving circuit from a power supply voltage and instead correlates the magnitude of the current flowing through the pixel driving circuit with a reference signal on the reference signal line.

### CROSS-REFERENCE TO RELATED APPLICATION

Pursuant to 35 U.S.C. § 119 and the Paris Convention, this application claims the benefit of Chinese Patent Application No. 202410874751.X filed on Jul. 2, 2024, the content of which is incorporated herein by reference.

### TECHNICAL FIELD

The present application relates to the field of optoelectronic technology, more particularly to a pixel driving circuit, a control method for the pixel driving circuit and a display device.

### BACKGROUND

The statements provided herein are merely background information related to the present application, and do not necessarily constitute any prior arts. Luminous brightness of an Organic light-emitting Diode (OLED) display device is related to the amount of current flowing through the device. The formula for a current I_{OLED} of the existing OLED driving circuit is:

$${I}_{OLED} = \frac{β}{2} {( {V}_{DAT} - {V}_{DID} - {V}_{TH} )}^{2} ,$$

where β is a constant, V_{DAT} is a data voltage of the driving circuit, V_{DD} is a power supply voltage of the driving circuit, and V_{TH} is a threshold voltage of the drive transistor in the driving circuit. It is well known that due to differences in the production process or the stress and aging effects of the drive transistor during use, V_{TH} may change over time or differ between devices of the same type. It can be seen from the above formula that even if V_{DAT} is the same, different drive transistors will cause differences in output current due to the variation of V_{TH}, which means that different display brightness may also appear under a given V_{DAT}.

Relevant technologies have attempted many solutions to address the drawbacks of the aforementioned mismatch in the characteristics of the drive transistors. However, the current solutions often have many problems. For example, problem 1 is that the threshold compensation and data writing may be completed within 1H (one line of) time, but the threshold compensation is not sufficient; problem 2 is that the voltage fluctuation on the power supply voltage line, such as IR voltage drop (IR drop) on the power supply voltage line, will have an impact on the OLED current; and problem 3 is that a leakage current in gate of the drive transistor is existed during a light-emitting phase, causing the brightness to change within a frame.

Therefore, it may be urgent to provide a new type of OLED pixel driving circuit to solve the aforementioned problem.

### SUMMARY

In view of this, a pixel driving circuit, a control method for the pixel driving circuit and a display device are provided in embodiments of the present application. The pixel driving circuit can make the current flowing through the pixel driving circuit unrelated to the power supply voltage through a source follower, but related to the reference signal on the reference signal line VREF, The pixel driving circuit utilizes a source follower configuration, which decouples the magnitude of the current flowing through the pixel driving circuit from a power supply voltage and instead correlates the magnitude of the current flowing through the pixel driving circuit with a reference signal on the reference signal line VREF, thereby the luminance non-uniformity in light-emitting elements can be effectively mitigated, resulting in superior light emission performance of the light-emitting elements.

In accordance with a first aspect of the embodiments of the present application, a pixel driving circuit is provided, which is configured to drive a light-emitting element to emit light cross multiple frame cycles, each frame cycle includes at least a first frame in a timing sequence, and the pixel driving circuit includes: a source follower sub-circuit, a driving sub-circuit, a data writing sub-circuit and a compensation sub-circuit, a first reset sub-circuit, a second reset sub-circuit and a light-emitting control sub-circuit.

The source follower sub-circuit is in electrical connection with a fourth node, a power supply voltage line and a second node, and is configured to set a voltage at the second node equal to a voltage of the fourth node.

The driving sub-circuit is in electrical connection with a first node, the second node and a first gate signal line, and is configured to establish a conductive path between the first node and the second node under a control of a gate signal on the first gate signal line, so as to generate a current for driving the light-emitting element to emit light in the conductive path.

The data writing sub-circuit is in electrical connection with a second gate signal line, a data signal line, a reference signal line and the fourth node, and is configured to write a data signal on the data signal line to the fourth node under a control of a gate signal on the second gate signal line.

The compensation sub-circuit is in electrical connection with the first gate signal line, the reference signal line and the fourth node, and is configured to set the voltage at the fourth node equal to a reference signal on the reference signal line under the control of the gate signal on the first gate signal line.

The first reset sub-circuit is in electrical connection with a third gate signal line, a first initialization signal line and the first node, and is configured to reset the first node through the initialization signal on the first initialization signal line under a control of a gate signal on the third gate signal line. The second reset sub-circuit is in electrical connection with the first gate signal line, the second initialization signal line and an anode of the light-emitting element, and is configured to reset the anode through the initialization signal on the second initialization signal line under the control of the gate signal on the first gate signal line.

The light-emitting control sub-circuit is in electrical connection with a light-emitting control signal line and a third node, and is configured to transmit the current for driving the light-emitting element emit light to the anode under a control of a light-emitting control signal on the light-emitting control signal line.

In one embodiment, each frame cycle also includes 2n frames in timing sequence, n is an integer greater than or equal to 1, and the pixel driving circuit also includes an adjustment sub-circuit.

The adjustment sub-circuit in electrical connection with the first initialization signal line and the first node, configured to adjust the voltage of the first node to match the initialization signal on the first initialization signal line in frames other than the first frame in the 2n frames.

In one embodiment, the source follower sub-circuit includes a source follower.

A control electrode of the source follower is in electrical connection with the fourth node, a first electrode of the source follower is in electrical connection with the power supply voltage line, and a second electrode of the source follower is in electrical connection with the second node.

In one embodiment, the driving sub-circuit includes a drive transistor and a fourth transistor.

A control electrode of the drive transistor is in electrical connection with the first node, a first electrode of the drive transistor is in electrical connection with the second node, and a second electrode of the drive transistor is in electrical connection with the first electrode of the fourth transistor.

A control electrode of the fourth transistor is in electrical connection with the first gate signal line, and a second electrode of the fourth transistor is in electrical connection with the first node.

In one embodiment, the data writing sub-circuit includes a second transistor and a first capacitor.

A control electrode of the second transistor is in electrical connection with the second gate signal line, a first electrode of the second transistor is in electrical connection with the data signal line, and a second electrode of the second transistor is in electrical connection with the fourth node;

A first end of the first capacitor is in electrical connection with the fourth node, and a second end of the first capacitor is in electrical connection with the reference signal line.

In one embodiment, the compensation sub-circuit includes a first transistor.

A control electrode of the first transistor is in electrical connection with the first gate signal line, a first electrode of the first transistor is in electrical connection with the reference signal line, and a second electrode of the first transistor is in electrical connection with the fourth node.

In one embodiment, the first reset sub-circuit includes a third transistor, a control electrode of the third transistor is in electrical connection with the third gate signal line, a first electrode of the third transistor is in electrical connection with the first initialization signal line, and a second electrode of the third transistor is in electrical connection with the first node.

The second reset sub-circuit includes a sixth transistor, a control electrode of the sixth transistor is in electrical connection with the first gate signal line, a first electrode of the sixth transistor is in electrical connection with the second initialization signal line, and a second electrode of the sixth transistor is in electrical connection with the third node.

The light-emitting control sub-circuit includes a fifth transistor, a control electrode of the fifth transistor is in electrical connection with the light-emitting control signal line, a first electrode of the fifth transistor is in electrical connection with the second node, and a second electrode of the fifth transistor is in electrical connection with the third node.

In one embodiment, the adjustment sub-circuit includes a second capacitor.

A first end of the second capacitor is in electrical connection with the first initialization signal line, and a second end of the second capacitor is in electrical connection with the first node.

In accordance with a second aspect of the embodiment of the present application, a display device is provided, which includes a plurality of pixel units arranged in an array and the pixel driving circuit as aforementioned, the pixel driving circuit is in electrical connection with the plurality of pixel units and is configured to control the plurality of pixel units.

In accordance with a third aspect of the embodiment of the present application, a control method for the pixel driving circuit, the control method includes that:

Within a single frame display cycle, a display of one frame of image is realized through a reset phase, a threshold compensation phase, a data writing phase and a light-emitting phase.

The pixel driving circuit provided in the first aspect of the embodiments of the present application employs a source follower to isolate the driving sub-circuit from the power supply voltage. As a result, the current flowing through the pixel driving circuit is independent of the power supply voltage. This ensures that the IR drop on the power supply voltage line will not cause uneven brightness of the pixel driving circuit. In addition, since the current flowing through the pixel driving circuit is correlated with the reference signal on the reference signal line, the small current flowing through the reference signal line results in a minimal voltage drop, which thus can effectively mitigate luminance non-uniformity of the light-emitting element. Consequently, a display device employing this pixel driving circuit achieves good brightness uniformity and good luminous performance.

The control method of the pixel driving circuit provided in the third aspect of the embodiments of the present application, the threshold voltage of the source follower and the drive transistor are compensated, the current of the light-emitting element is not related to the power supply voltage, so the influence of the uneven power supply voltage on the display can be reduced. The current of the light-emitting element is related to the reference signal, since the current flowing through the reference signal line is small, the voltage drop of the reference signal line is also small, and the uneven brightness of the light-emitting element can be effectively improved, and the threshold compensation and data writing are completed in two phases, the threshold compensation can be more sufficient, thereby the light-emitting element can be driven by the pixel driving circuit to emit light, which is simple and easy to implement.

It can be understood that the beneficial effects of the second aspect mentioned above can be found in the relevant descriptions of the first and third aspects mentioned above, and will not be repeated here.

### BRIEF DESCRIPTION OF DRAWINGS

In order to illustrate the technical solutions in the embodiments of the present application more clearly, the drawings that required to be used for description of the embodiment will be briefly introduced below. Obviously, the drawings described below are merely some embodiments of the present application. For a person of ordinary skill in the art, other drawings may be obtained based on these drawings on the premise of paying no creative labor.

FIG. 1 is a schematic diagram of a pixel driving circuit provided in an embodiment of the present application;

FIG. 2 is a schematic diagram of another pixel driving circuit provided in an embodiment of the present application;

FIG. 3 is a schematic diagram of a control method of a pixel driving circuit provided in an embodiment of the present application;

FIG. 4 is a driving timing diagram of the pixel driving circuit provided in an embodiment of the present application;

FIG. 5 is a driving timing diagram of another pixel driving circuit provided in an embodiment of the present application;

FIGS. 6-9 are schematic diagrams of a driving principle of the pixel driving circuit of FIG. 1 under the driving timing of FIG. 4; and

FIGS. 10-13 are schematic diagrams of a driving principle of the pixel driving circuit of FIG. 2 under the driving timing of FIG. 5.

### REFERENCE SIGNS IN THE DRAWINGS

1—first reset sub-circuit, 2—compensation sub-circuit, 3—driving sub-circuit, 4—second reset sub-circuit, 5—data writing sub-circuit, 6—light-emitting control sub-circuit, 7—source follower sub-circuit, 8—adjustment sub-circuit.

### DETAILED DESCRIPTION OF EMBODIMENTS

In order to enable personnel in the field of this technology to better understand the scheme of the present application, the technical schemes in the embodiments of the present application will be clearly and completely described in combination with the drawings in the embodiment of the present application. Obviously, the described embodiments are merely some embodiments of the present application, not all of the embodiments. Based on the embodiments in the present application, other embodiments obtained by ordinary technicians in the field without paying creative efforts should all fall within the protection scope of the present application.

The term “including” and any variations in the specification and claims of the present application and the drawings are intended to cover non-exclusive inclusions, for example, a process, a method or a system, a product or a device including a series of steps or units is not limited to the listed steps or units, but optionally also includes steps or units that are not listed, or optionally also includes other steps or units inherent to the process, the method, the product or the device.

In the embodiments of the present application, the words “first”, “second”, “fourth”, “fifth”, “sixth” and the like are used to distinguish the same or similar items with basically the same functions and effects, which is only for the purpose of clearly describing the technical solutions of the embodiments of the present application, and should not be understood as indicating or implying relative importance or implicitly indicating the quantity of the indicated feature.

In the embodiments of the present application, the gate of the transistor or the source follower is referred to as the control electrode, and one of the source and drain is referred to as the first electrode, while the other is referred to as the second electrode. In the embodiments of the present application, the first electrode of the source follower or any of the transistors is referred to as the source, and the second electrode is referred to as the drain, as an example for illustration.

In the embodiments of the present application, the term “electrically connected” may refer to the direct electrical connection between two components, or may refer to the electrical connection between two components via one or more other components.

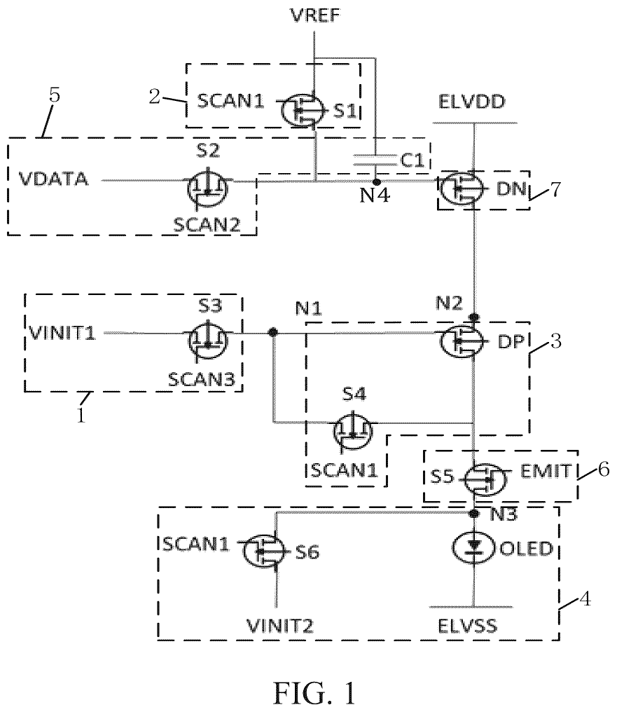

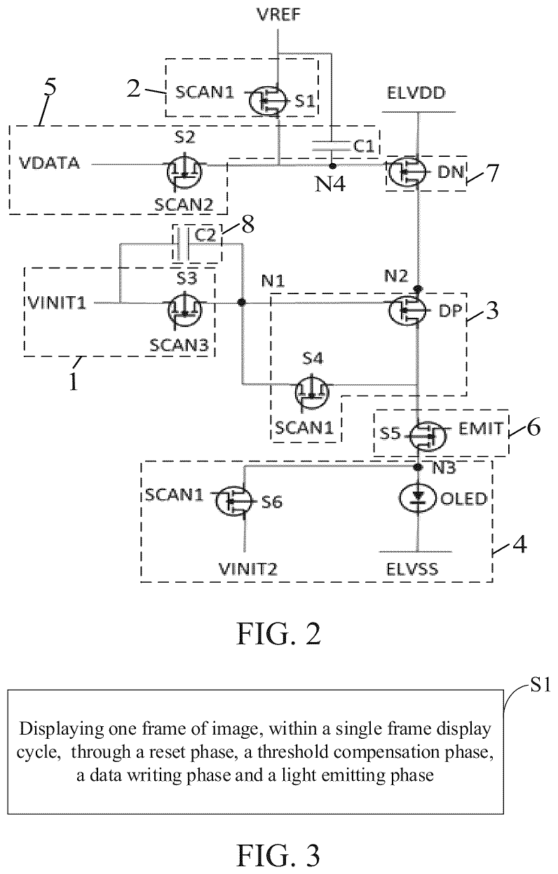

An embodiment of the present application provides a pixel driving circuit, which is configured to drive a light-emitting element to emit light across multiple frame cycles, each frame cycle includes at least a first frame in a timing sequence. Referring to FIG. 1 and FIG. 2, the pixel driving circuit includes: a source follower sub-circuit 7, a driving sub-circuit 3, a data writing sub-circuit 5 and a compensation sub-circuit 2, a first reset sub-circuit 1, a second reset sub-circuit 4 and a light-emitting control sub-circuit 6.

The source follower sub-circuit 7 is in electrical connection with a fourth node N4, a power supply voltage line ELVDD and a second node N2, and is configured to set a voltage at the second node N2 equal to a voltage at the fourth node N4.

The driving sub-circuit 3 is in electrical connection with a first node N1, the second node N2 and a first gate signal line SCAN1, and is configured to establish a conductive path between the first node N1 and the second node N2 under a control of a gate signal on the first gate signal line SCAN1, so as to generate a current for driving the light-emitting element to emit light in the conductive path.

The data writing sub-circuit 5 is in electrical connection with a second gate signal line SCAN2, a data signal line VDATA, a reference signal line VREF and the fourth node N4, and is configured to write a data signal on the data signal line VDATA to the fourth node N4 under a control of a gate signal on the second gate signal line SCAN2.

The compensation sub-circuit 2 is in electrical connection with the first gate signal line SCAN1, the reference signal line VREF and the fourth node N4, and is configured to set the voltage at the fourth node N4 equal to a reference signal on the reference signal line VREF under the control of the gate signal on the first gate signal line SCAN1.

The first reset sub-circuit 1 is in electrical connection with a third gate signal line SCAN3, a first initialization signal line VINIT1 and the first node N1, and is configured to reset the first node N1 through an initialization signal on the first initialization signal line VINIT1 under a control of a gate signal on the third gate signal line SCAN3.

The second reset sub-circuit 4 is in electrical connection with the first gate signal line SCAN1, a second initialization signal line VINIT2 and an anode of the light-emitting element, and is configured to reset the anode of the light-emitting element through an initialization signal on the second initialization signal line VINIT2 under the control of the gate signal on the first gate signal line SCAN1.

The light-emitting control sub-circuit 6 is in electrical connection with a light-emitting control signal line EMIT and a third node N3, and is configured to transmit the current for driving the light-emitting element to emit light to the anode of the light-emitting element under a control of a light-emitting control signal on the light-emitting control signal line EMIT.

As shown in FIG. 1 and FIG. 2, the anode of the light-emitting element may be in electrical connection with the third node N3, and a cathode of the light-emitting element may be electrically connected to a ground terminal ELVSS.

Specific circuit structures of the source follower sub-circuit, the driving sub-circuit, the data writing sub-circuit, the compensation sub-circuit, the first reset sub-circuit, the second reset sub-circuit and the light-emitting control sub-circuit are not limited in here, as long as the corresponding functions are met.

The first node, second node, third node and fourth node are defined only for the convenience of describing the circuit structure. The first node, second node, third node and fourth node are not an actual circuit unit.

If the pixel driving circuit is applied to an OLED display device, the light-emitting element is an organic light-emitting element. If the pixel driving circuit is applied to a Mini light-emitting Diode (Mini LED) display device or a Micro light-emitting Diode (Micro LED) display device, the light-emitting element is Mini LED or Micro LED.

The pixel driving circuit provided in the embodiment of the present application can isolate the driving sub-circuit from the power supply voltage on the power supply voltage line ELVDD by using a source follower, and the current flowing through the pixel driving circuit is not related to the power supply voltage, so that the IR drop on the power supply voltage line ELVDD will not cause uneven brightness of the pixel driving circuit. In addition, since the current flowing through the pixel driving circuit is correlated with the reference signal on the reference signal line VREF, the small current flowing through reference signal line VREF results in a minimal voltage drop, which thus can effectively mitigate luminance non-uniformity of the light-emitting element. Consequently, a display device employing this pixel driving circuit achieves good brightness uniformity and good luminous performance.

In one embodiment, each frame cycle includes 2n frames in timing sequence, where n is an integer greater than or equal to 1, and as shown in FIG. 2, the pixel driving circuit also includes an adjustment sub-circuit 8.

The adjustment sub-circuit 8 is in electrical connection with the first initialization signal line VINIT1 and the first node N1, and is configured to adjust the voltage at the first node N1 to match the initialization signal on the first initialization signal line VINIT1 in other frames except the first frame in the 2n frames.

FIG. 2 takes n=2 as an example for illustration. At this time, each frame cycle includes a first frame, a second frame, a third frame and a fourth frame in timing sequence. The pixel driving circuit also includes an adjustment sub-circuit 8.

The adjustment sub-circuit 8 is in electrical connection with the first initialization signal line VINIT1 and the first node N1, and is configured to adjust the voltage of the first node N1 to match the initialization signal on the first initialization signal line VINIT1 in the second frame, the third frame and the fourth frame.

Further, n=1, 2, 3, 4, 5, 6.

The pixel driving circuit provided in this embodiment of the application adopts a frame-split (pulse) configuration for the initialization signal of the first initialization signal line VINIT1 and sets multiple pulses for the light-emitting control signal of the light-emitting control signal line EMIT. The initialization signal on the first initialization signal line VINIT1 varies with the pulse variations of the light-emitting control signal on the light-emitting control signal line EMIT, so that different pulses can set different initialization signals on the first initialization signal line VINIT1, thereby effectively addressing the issue of uneven brightness within a single frame caused by the leakage current at the first node N1 during a light-emitting control phase.

In one embodiment, as shown in FIG. 1 and FIG. 2, the source follower sub-circuit 7 includes a source follower DN. A control electrode of the source follower DN is in electrical connection with the fourth node N4, a first electrode of the source follower DN is in electrical connection with the power supply voltage line ELVDD, and a second electrode of the source follower DN is in electrical connection with the second node N2.

In practical applications, an output of the source follower DN follows an input voltage, that is, the input signal is applied to the control electrode of the source follower DN, while the output signal is obtained from the drain of the source follower DN.

It should be noted that the power supply voltage signal on the power supply voltage line ELVDD in the embodiment of the present application does not control the light emission of the light-emitting element in the pixel driving circuit, and a flow direction of the light-emitting current is determined by both the power supply voltage line ELVDD and the ground terminal ELVSS.

In one embodiment, referring to FIG. 1 and FIG. 2, the driving sub-circuit 3 includes a drive transistor DP and a fourth transistor S4. A control electrode of the drive transistor DP is in electrical connection with the first node N1, a first electrode of the drive transistor DP is in electrical connection with the second node N2, and a second electrode of the drive transistor DP is in electrical connection with a first electrode of the fourth transistor S4. A control electrode of the fourth transistor S4 is in electrical connection with the first gate signal line SCAN1, and a second electrode of the fourth transistor S4 is in electrical connection with the first node N1.

In one embodiment, referring to FIG. 1 and FIG. 2, the data writing sub-circuit 5 includes a second transistor S2 and a first capacitor C1. A control electrode of the second transistor S2 is in electrical connection with the second gate signal line SCAN2, a first electrode of the second transistor S2 is in electrical connection with the data signal line VDATA, and a second electrode of the second transistor S2 is in electrical connection with the fourth node N4. A first end of the first capacitor C1 is in electrical connection with the fourth node N4, and a second end of the first capacitor C1 is in electrical connection with the reference signal line VREF.

It should be noted that the second electrode of the second transistor S2 is in electrical connection with the fourth node N4, and the first end of the first capacitor C1 is in electrical connection with the fourth node N4, that is, the second electrode of the second transistor S2 is in electrical connection with the first end (first plate) of the first capacitor C1.

In one embodiment, as shown in FIG. 1 and FIG. 2, the compensation sub-circuit 2 includes a first transistor S1. A control electrode of the first transistor S1 is in electrical connection with the first gate signal line SCAN1, a first electrode of the first transistor S1 is in electrical connection with the reference signal line VREF, and a second electrode of the first transistor S1 is in electrical connection with the fourth node N4.

In one embodiment, as shown in FIG. 1 and FIG. 2, the first reset sub-circuit 1 includes a third transistor S3. A control electrode of the third transistor S3 is in electrical connection with the third gate signal line SCAN3, a first electrode of the third transistor S3 is in electrical connection with the first initialization signal line VINIT1, and a second electrode of the third transistor S3 is in electrical connection with the first node N1.

In one embodiment, as shown in FIG. 1 and FIG. 2, the second reset sub-circuit 4 includes a sixth transistor S6. A control electrode of the sixth transistor S6 is in electrical connection with the first gate signal line SCAN1, a first electrode of the sixth transistor S6 is in electrical connection with the second initialization signal line VINIT2, and a second electrode of the sixth transistor S6 is in electrical connection with the third node N3.

It should be noted that the second electrode of the sixth transistor S6 is in electrical connection with the third node N3, and the anode of the light-emitting element is in electrical connection with the third node N3, that is, the second electrode of the sixth transistor S6 is in electrical connection with the anode of the light-emitting element.

In one embodiment, referring to FIG. 1 and FIG. 2, the light-emitting control sub-circuit 6 includes a fifth transistor S5. A control electrode of the fifth transistor S5 is in electrical connection with the light-emitting control signal line EMIT, a first electrode of the fifth transistor S5 is in electrical connection with the second node N2, and a second electrode of the fifth transistor S5 is in electrical connection with the third node N3.

In one embodiment, referring to FIG. 2, the adjustment sub-circuit 8 includes a second capacitor C2. A first end of the second capacitor C2 is in electrical connection with the first initialization signal line VINIT1, and a second end of the second capacitor C2 is in electrical connection with the first node N1.

In practical applications, the first transistor S1, the second transistor S2, the third transistor S3, the fourth transistor S4, the fifth transistor S5, the sixth transistor S6 and the drive transistor DP may be non-oxide transistors, oxide transistors, etc. The non-oxide transistor may include a low temperature poly-silicon (LTPS), etc., which is not specifically limited here.

In order to achieve uniformity in the manufacturing process and facilitate a simpler driving method for subsequent circuits, the aforementioned first transistor S1, second transistor S2, third transistor S3, fourth transistor S4, fifth transistor S5, sixth transistor S6 and driving transistor DP may all be P-type transistors, and the source follower DN may be an N-type source follower. It should be noted that the first transistor S1, the second transistor S2, the third transistor S3, the fourth transistor S4, the fifth transistor S5, the sixth transistor S6 and the drive transistor DP may also all be N-type transistors, and the source follower DN may also be an N-type source follower. In the case where the first transistor S1, the second transistor S2, the third transistor S3, the fourth transistor S4, the fifth transistor S5, the sixth transistor S6 and the drive transistor DP are N-type transistors and the source follower DN is an N-type source follower, the design principle is similar to that of this embodiment and also falls within the scope of protection of the embodiments of the present application.

An embodiment of the present application provides a display device, which includes a plurality of pixel units arranged in an array and the pixel driving circuit as described in the above embodiments. The pixel driving circuit is in electrical connection with the plurality of pixel units and is configured to control the plurality of pixel units.

The display device may be a flexible display device (also known as a flexible screen) or a rigid display device (i.e., a display screen that cannot be bent), which is not limited here.

The display device may be an OLED display device, or a Micro LED display device or a Mini LED display device, as well as any product or component with a display function such as a TV, a digital camera, a mobile phone, a tablet computer, etc. including the display device. The display device may also be applied to fields such as identity recognition and medical equipment, and products that have been promoted or have good promotion prospects including security identity authentication, smart door locks, medical image acquisition, etc.

The display device has the advantages of good luminance effect, low cost, excellent display effect, long service life, high stability, high contrast ratio, good imaging quality and high product quality.

An embodiment of the present application provides a control method for the pixel driving circuit as described in the above embodiments.

As shown in FIG. 3, the control method includes a step S1.

In step S1, within a single frame display cycle, a display of one frame of image is achieved through a reset phase, a threshold compensation phase, a data writing phase, and a light-emitting phase.

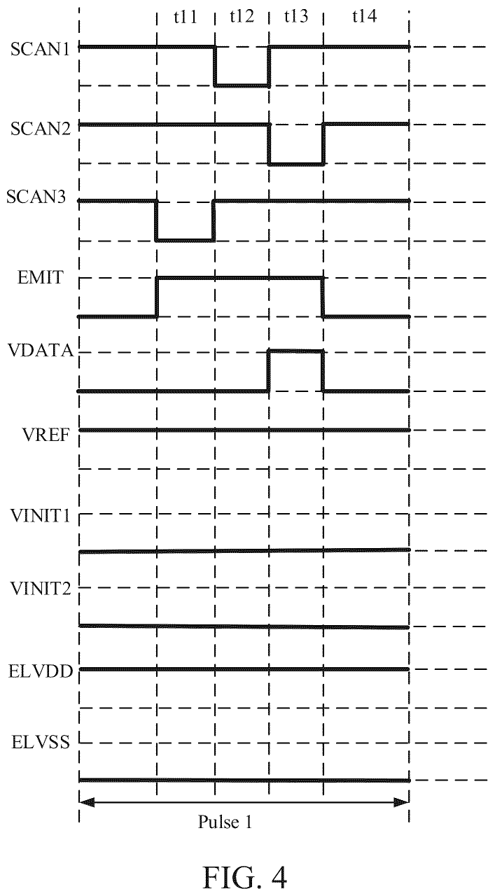

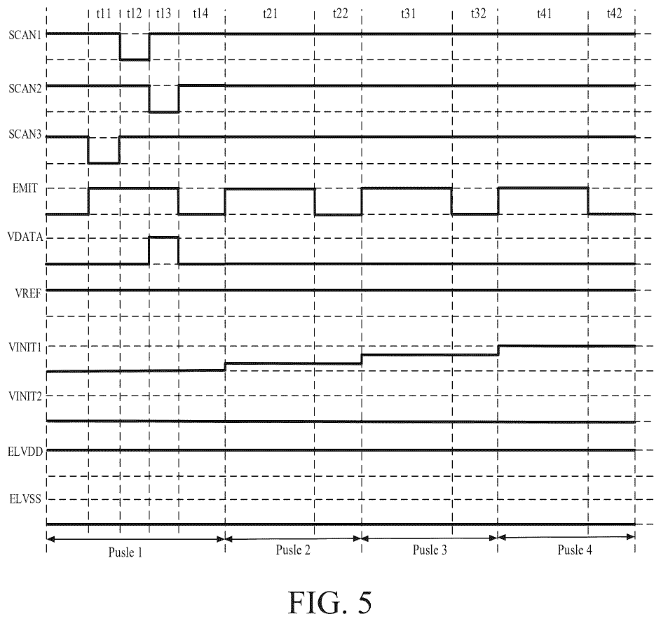

The operating timing sequence of the pixel driving circuit in the embodiments of the present application may refer to FIGS. 4 and 5, and the specific description is as follows.

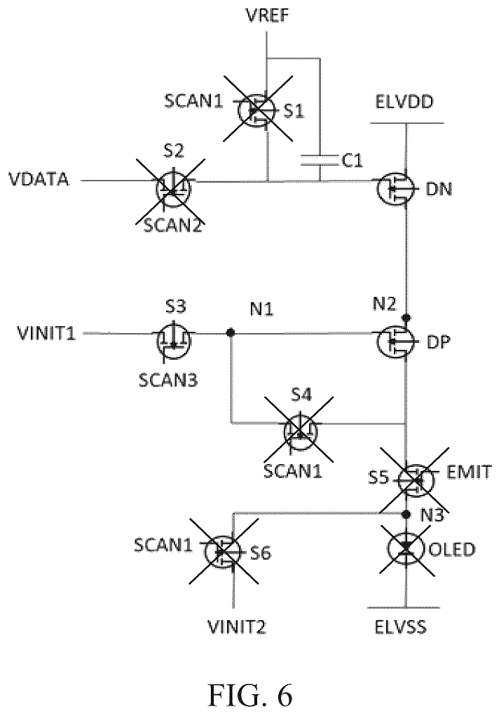

In the following, taking that the source follower DN is an N-type source follower, the first transistor S1, the second transistor S2, the third transistor S3, the fourth transistor S4, the fifth transistor S5, the sixth transistor S6 and the drive transistor DP are all P-type lo-temperature poly-silicon transistors, and the light-emitting element is an OLED as an example, the operating principle of the pixel driving circuit shown in FIG. 1 provided in the embodiment of the present application is described in detail with reference to the timing diagram of each signal line as shown in FIG. 4. It should be noted that in FIGS. 6 to 9, the transistors and source followers being switched off are marked by “x”, and that the light-emitting elements do not emit light are also marked by “x”.

### The First Frame (Pulse 1):

In N1 initialization phase of the first frame, that is, the t11 phase in FIG. 4, high-level signals are input to the first gate signal line SCAN1, the second gate signal line SCAN2, the light-emitting control signal line EMIT, the reference signal line VREF, and the power supply voltage line ELVDD, and low-level signals are input to the third gate signal line SCAN3, the data signal line VDATA, the data signal line VDATA, the first initialization signal line VINIT1, the second initialization signal line VINIT2, and the ground terminal ELVSS. At this time, referring to FIG. 6, the first transistor S1, the second transistor S2, the fourth transistor S4, the fifth transistor S5, and the sixth transistor S6 are all switched off, and the third transistor S3 is switched on. Since the third transistor S3 is switched on, the initialization signal on the first initialization signal line VINIT1 can be written into the first node N1, and the first node N1 is initialized to the initialization signal on the first initialization signal line VINIT1.

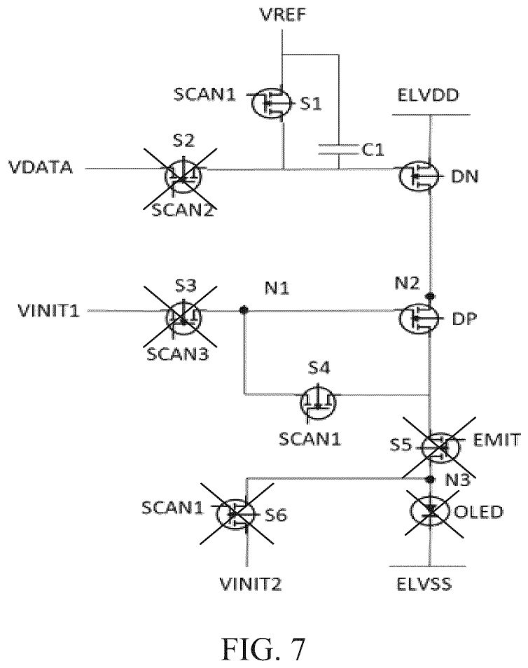

In a threshold compensation and N3 initialization phase of the first frame, i.e., phase t12 in FIG. 4, high-level signals are input to the second gate signal line SCAN2, the third gate signal line SCAN3, the light-emitting control signal line EMIT, the reference signal line VREF, and the power supply voltage line ELVDD, and low-level signals are input to the first gate signal line SCAN1, the data signal line VDATA, the first initialization signal line VINIT1, the second initialization signal line VINIT2, and the ground terminal ELVSS. At this time, referring to FIG. 7, the second transistor S2, the third transistor S3, and the fifth transistor S5 are all switched off, and the first transistor S1, the fourth transistor S4, and the sixth transistor S6 are all switched on. Since the sixth transistor S6 is switched on, the third node N3 and the anode of the light-emitting element are reset, and the third node N3 and the anode of the light-emitting element are reset to the initialization signal on the second initialization signal line VINIT2.

Moreover, since the first transistor S1 is switched on, the reference signal on the reference signal line VREF is written into the control electrode of the source follower DN, and then transmitted from the control electrode of the source follower DN to the drain of the source follower DN. As the source follower DN is switched off, the voltage of the second node N2 is expressed as V_{REF}−V_{THN} (V_{REF} is the reference voltage of the source follower DN, and V_{THN} is the threshold voltage of the source follower DN). Since the voltage of the first node N1 is about VINIT1, which is lower than the voltage of the second node N2, the drive transistor DP is switched on, and when the V_{GS} of the drive transistor DP is equal to V_{THP} (V_{GS} is the gate-source voltage of the drive transistor DP, and V_{THP} is the threshold voltage of the drive transistor DP), the drive transistor DP is switched off. As the drive transistor DP is switched off, the voltage of the first node N1 is expressed as V_{REF}−VT_{HN}−|V_{THP}|.

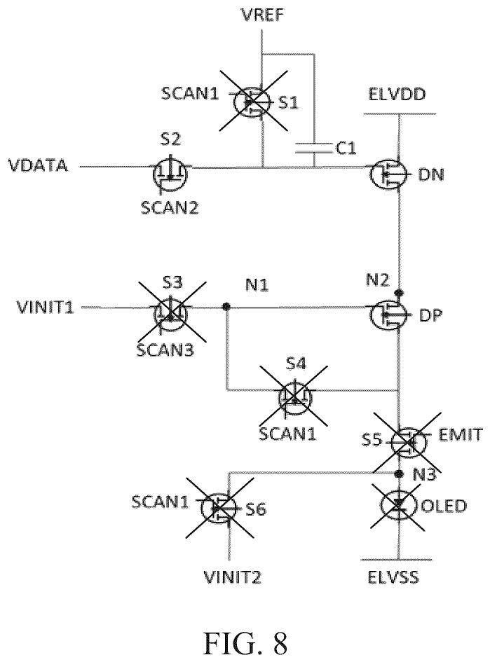

In a data writing phase of the first frame, i.e., phase t13 in FIG. 4, high-level signals are input to the first gate signal line SCAN1, the third gate signal line SCAN3, the data signal line VDATA, the light-emitting control signal line EMIT, the reference signal line VREF, and the power supply voltage line ELVDD, and low-level signals are input to the second gate signal line SCAN2, the first initialization signal line VINIT1, the second initialization signal line VINIT2, and the ground terminal ELVSS. At this time, referring to FIG. 8, the first transistor S1, the third transistor S3, the fourth transistor S4, the fifth transistor S5, and the sixth transistor S6 are all switched off, and the second transistor S2 is switched on. Since the second transistor T2 is switched on, the data signal on the data signal line VDATA is written to the first plate of the first capacitor C1, and the first capacitor C1 is charged.

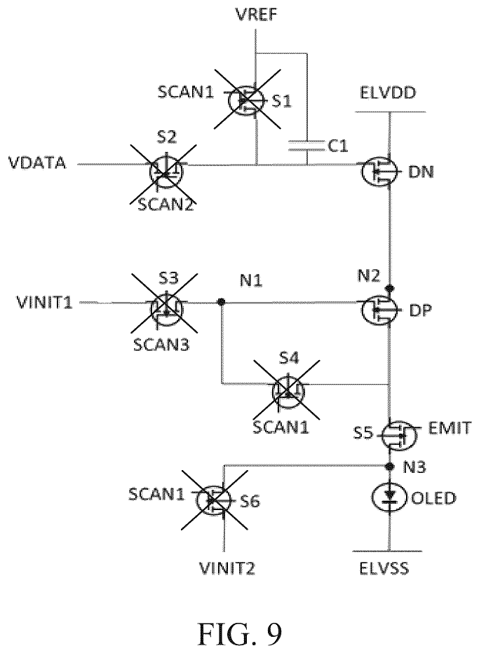

In a light-emitting phase of the first frame, i.e., phase t14 in FIG. 4, high-level signals are input to the first gate signal line SCAN1, the second gate signal line SCAN2, the third gate signal line SCAN3, the reference signal line VREF, and the power supply voltage line ELVDD, and low-level signals are input to the data signal line VDATA, the light-emitting control signal line EMIT, the first initialization signal line VINIT1, the second initialization signal line VINIT2, and the ground terminal ELVSS. At this time, referring to FIG. 9, the first transistor S1, the second transistor S2, the third transistor S3, the fourth transistor S4, and the sixth transistor S6 are all switched off, and the fifth transistor S5, the drive transistor DP, and the source follower DN are all switched on. Since the fifth transistor S5, the drive transistor DP, and the source follower DN are all switched on, at this time, the current input from the first node N1 flows into the anode of the light-emitting element, thereby driving the light-emitting element to emit light.

In the above process, the current I_{DN} flowing through the source follower DN is given by:

$${I}_{DN} = ( β {T}_{DN} / 2 \times {( {V}_{DATA} - {V}_{N 2} - {V}_{THN} )}^{2} ) , β {T}_{DN} = {μ}_{DN} \times {C}_{OXN} \times ( wn / Ln ) ,$$

where C_{OXN} is a capacitance of the gate oxide of the source follower DN, Wn is a channel width of the source follower DN, Ln is a channel length of the source follower DN, μ_{DN} is a carrier mobility of the source follower DN, βT_{DN} is an intermediate variable with no physical meaning, VDATA is the data signal (data voltage) of the data signal line VDATA, and V_{N2} is the voltage at the second node N2.

The current I_{DP} flowing through the drive transistor DP is given by:

$${I}_{DP} = ( β {T}_{DP} / 2 \times {( {V}_{N 2} - {V}_{N 1} - {V}_{THP} )}^{2} ) , β {T}_{DN} = {μ}_{DN} \times {C}_{OXN} \times ( wp / Lp ) ,$$

when Coxp is a capacitance of the gate oxide of the drive transistor DP, Wp is a channel width of the drive transistor DP, Lp is a channel length of the drive transistor DP, μ_{DP} is a carrier mobility of the drive transistor DP, βT_{DP} is an intermediate variable with no physical meaning, V_{N1} is the data signal (data voltage) of the data signal line VDATA, and V_{N2} is the voltage at the second node N2.

From the condition I_{DN}=I_{DP}, I_{OLED}=I_{DN}=I_{DP}={[βT_{DN}×βT_{DP}]/[2(\sqrt{βT_{DN}}+\sqrt{βT_{DP}})²]}×(V_{REF}−V_{DATA})² is got, where I_{OLED} is the current that drives the OLED to emit light.

In the control method for the pixel driving circuit provided by the embodiment of the present application, the threshold voltages of the source follower DN and the drive transistor DP are compensated. The magnitude of current of the OLED is not related to the power supply voltage from the power supply voltage line ELVDD, which can reduce the influence of the unevenness of ELVDD on the display. The magnitude of current of the OLED is related to the reference signal from the reference signal line VREF. The smaller the current flowing through the reference signal line VREF, the smaller the voltage drop across the reference signal line VREF. This can effectively improve the uneven brightness of the OLED. The threshold compensation and data writing are completed in two phases, and the threshold compensation can be more sufficient. At the same time, the control method can realize the driving of the light-emitting element for emitting light by the above-mentioned pixel driving circuit, and the timing sequence is simple and easy to implement.

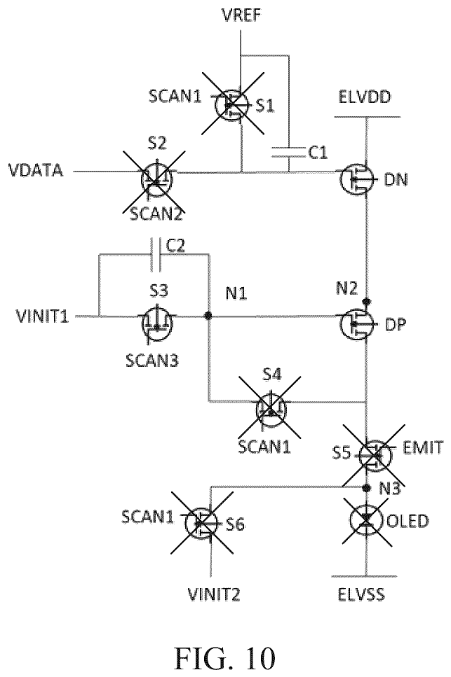

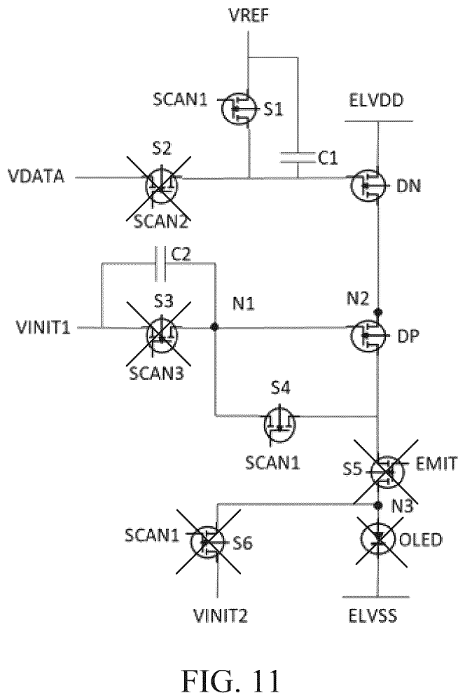

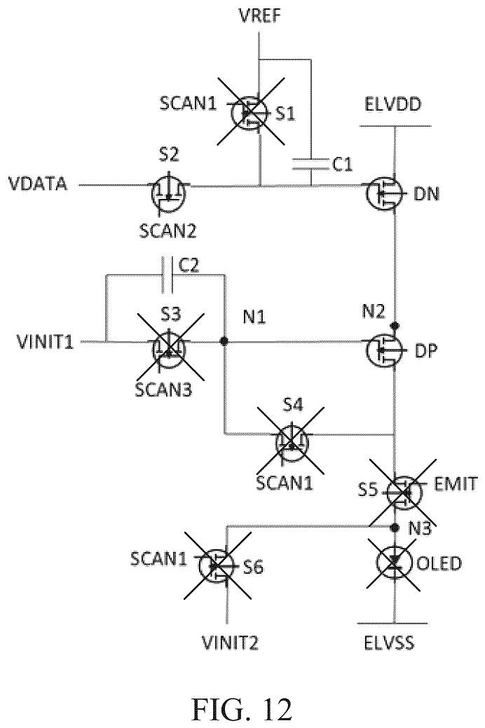

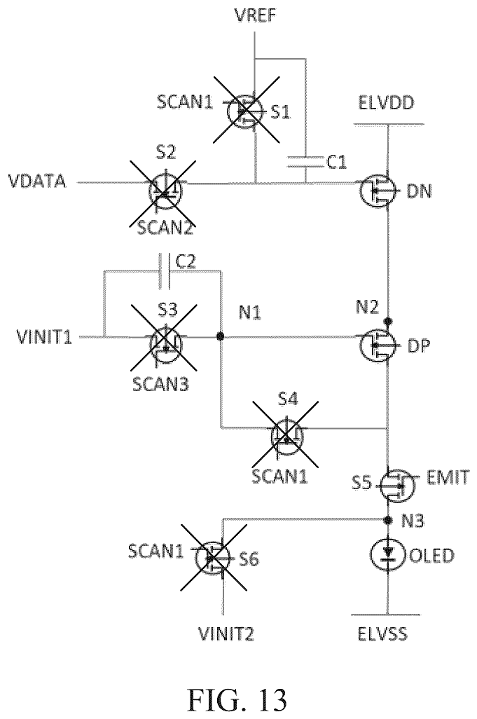

In one embodiment, taking that the source follower DN is an N-type source follower, the first transistor S1, the second transistor S2, the third transistor S3, the fourth transistor S4, the fifth transistor S5, the sixth transistor S6 and the drive transistor DP are all P-type low temperature poly-silicon transistors, and the light-emitting element is an OLED as an example, the operating principle of the pixel driving circuit shown in FIG. 2 provided in the embodiment of the present application is described in detail with reference to the timing diagram of each signal line as shown in FIG. 5. It should be noted that in FIGS. 10 to 13, the transistors and source followers being switched off are marked by the “x”, and the light-emitting elements do not emit light are also marked by the “x”.

It should be noted that the light-emitting principle of the first frame (pulse 1) is the same as the above embodiment, and will not be repeated here.

### The Second Frame (Pulse 2):

In phase t21: high-level signals are input to the first gate signal line SCAN1, the second gate signal line SCAN2, the third gate signal line SCAN3, the light-emitting control signal line EMIT, the reference signal line VREF, and the power supply voltage line ELVDD, and low-level signals are input to the data signal line VDATA, the second initialization signal line VINIT2, and the ground terminal ELVSS. At this time, the voltage level of the first initialization signal line VINIT1 is slightly higher than that of the pulse 1.

In phase t22: high-level signals are input to the first gate signal line SCAN1, the second gate signal line SCAN2, the third gate signal line SCAN3, the reference signal line VREF, and the power supply voltage line ELVDD, and low-level signals are input to the light-emitting control signal line EMIT, the data signal line VDATA, the second initialization signal line VINIT2, and the ground terminal ELVSS. At this time, the voltage level of the first initialization signal line VINIT1 is slightly higher than that of the pulse 1.

### The Third Frame (Pulse 3):

In phase t31: high-level signals are input to the first gate signal line SCAN1, the second gate signal line SCAN2, the third gate signal line SCAN3, the light-emitting control signal line EMIT, the reference signal line VREF, and the power supply voltage line ELVDD, and low-level signals are input to the data signal line VDATA, the second initialization signal line VINIT2, and the ground terminal ELVSS. At this time, the voltage level of the first initialization signal line VINIT1 is slightly higher than that of the pulse 2.

In phase t32: high-level signals are input to the first gate signal line SCAN1, the second gate signal line SCAN2, the third gate signal line SCAN3, the reference signal line VREF, and the power supply voltage line ELVDD, and low-level signals are input to the light-emitting control signal line EMIT, the data signal line VDATA, the second initialization signal line VINIT2, and the ground terminal ELVSS. At this time, the voltage level of the first initialization signal line VINIT1 is slightly higher than that of the pulse 2.

### The Fourth Frame (Pulse 4):

In phase t41: high-level signals are input to the first initialization signal line VINIT1, the first gate signal line SCAN1, the second gate signal line SCAN2, the third gate signal line SCAN3, the light-emitting control signal line EMIT, the reference signal line VREF, and the power supply voltage line ELVDD, and low-level signals are input to the data signal line VDATA, the second initialization signal line VINIT2, and the ground terminal ELVSS.

In phase t42: high-level signals are input to the first initialization signal line VINIT1, the first gate signal line SCAN1, the second gate signal line SCAN2, the third gate signal line SCAN3, the reference signal line VREF, and the power supply voltage line ELVDD, and low-level signals are input to the light-emitting control signal line EMIT, the data signal line VDATA, the second initialization signal line VINIT2, and the ground terminal ELVSS.

From the above, it can be seen that after Pulse 1, all other signals remain unchanged, with only the OLED emitting light.

It should be noted that the capacitance of the second capacitor C2 in the embodiment of the present application is much smaller than the capacitance of the first capacitor C1.

The voltage at the first node N1 determines the luminance of the OLED. For example, a higher voltage at the first node N1 results in a dimmer OLED emission.

In the control method of the pixel driving circuit provided in the embodiment of the present application, at the moments when pulse 1 jumps to pulse 2, pulse 2 jumps to pulse 3, and pulse 3 jumps to pulse4, since all transistors have capacitance to the first node N1, resulting in resistance, in this case, if the voltage level of the initialization signal on the first initialization signal line VINIT1 becomes higher, then the voltage at the first node N1 follows the initialization signal on the first initialization signal line VINIT1 based on the charging and pull-down effects of the second capacitor C2. For instance, when the voltage level of the initialization signal on the first initialization signal line VINIT1 decreases, the voltage at the first node N1 is pulled down through the charging and pull-down effects of capacitor C2. Conversely, when the voltage level of the initialization signal on VINIT1 increases, the voltage at the first node N1 is pulled up through the charging and pull-down effects of C2. This mechanism effectively mitigates the issue of uneven brightness within one frame caused by leakage current at the first node N1 during the emission phase.

Only the content related to the invention point is introduced here, and other structures may be obtained by referring to the relevant technology, which will not be described in detail here.

The above illustrates only some preferred embodiments of the present application, and is not intended to limit the present application. Any modifications, equivalent substitutions and improvements made within the spirit and principles of the present application shall all be included within the protection scope of the present application.

What is claimed is:

1. A pixel driving circuit, configured to drive a light-emitting element to emit light across multiple frame cycles, each of the multiple frame cycles comprising at least a first frame in a timing sequence, and the pixel driving circuit comprising:
a source follower sub-circuit, in electrical connection with a fourth node, a power supply voltage line and a second node, configured to set a voltage at the second node equal to a voltage of the fourth node;
a driving sub-circuit, in electrical connection with a first node, the second node and a first gate signal line, configured to establish a conductive path between the first node and the second node under a control of a gate signal on the first gate signal line, so as to generate a current for driving the light-emitting element to emit light in the conductive path;
a data writing sub-circuit, in electrical connection with a second gate signal line, a data signal line, a reference signal line and the fourth node, configured to write a data signal on the data signal line to the fourth node under a control of a gate signal on the second gate signal line;
a compensation sub-circuit, in electrical connection with the first gate signal line, the reference signal line and the fourth node, and configured set the voltage at the fourth node equal to a reference signal on the reference signal line under the control of the gate signal on the first gate signal line;
a first reset sub-circuit, in electrical connection with a third gate signal line, a first initialization signal line and the first node, and configured to reset the first node through the initialization signal on the first initialization signal line under a control of a gate signal on the third gate signal line;
a second reset sub-circuit, in electrical connection with the first gate signal line, the second initialization signal line and an anode of the light-emitting element, and configured to reset the anode of the light-emitting element through the initialization signal on the second initialization signal line under the control of the gate signal on the first gate signal line; and
a light-emitting control sub-circuit, in electrical connection with a light-emitting control signal line and a third node, and configured to transmit the current for driving the light-emitting element emit light to the anode of the light-emitting element under a control of a light-emitting control signal on the light-emitting control signal line.

2. The pixel driving circuit according to claim 1, wherein each frame cycle comprises 2n frames in timing sequence, wherein n is an integer greater than or equal to 1, and the pixel driving circuit further comprises:
an adjustment sub-circuit which is in electrical connection with the first initialization signal line and the first node, configured to adjust a voltage at the first node to match the initialization signal on the first initialization signal line in frames other than the first frame in the 2n frames.

3. The pixel driving circuit according to claim 1, wherein the source follower sub-circuit comprises a source follower;
a control electrode of the source follower is in electrical connection with the fourth node, a first electrode of the source follower is in electrical connection with the power supply voltage line, and a second electrode of the source follower is in electrical connection with the second node.

4. The pixel driving circuit according to claim 1, wherein the driving sub-circuit comprises a drive transistor and a fourth transistor;
a control electrode of the drive transistor is in electrical connection with the first node, a first electrode of the drive transistor is in electrical connection with the second node, and a second electrode of the drive transistor is in electrical connection with a first electrode of the fourth transistor; and
a control electrode of the fourth transistor is in electrical connection with the first gate signal line, and a second electrode of the fourth transistor is in electrical connection with the first node.

5. The pixel driving circuit according to claim 1, wherein the data writing sub-circuit comprises a second transistor and a first capacitor;
a control electrode of the second transistor is in electrical connection with the second gate signal line, a first electrode of the second transistor is in electrical connection with the data signal line, and a second electrode of the second transistor is in electrical connection with the fourth node; and
a first end of the first capacitor is in electrical connection with the fourth node, and a second end of the first capacitor is in electrical connection with the reference signal line.

6. The pixel driving circuit according to claim 1, wherein the compensation sub-circuit comprises a first transistor;
a control electrode of the first transistor is in electrical connection with the first gate signal line, a first electrode of the first transistor is in electrical connection with the reference signal line, and a second electrode of the first transistor is in electrical connection with the fourth node.

7. The pixel driving circuit according to claim 1, wherein the first reset sub-circuit comprises a third transistor, a control electrode of the third transistor is in electrical connection with the third gate signal line a first electrode of the third transistor is in electrical connection with the first initialization signal line, and a second electrode of the third transistor is in electrical connection with the first node;
the second reset sub-circuit comprises a sixth transistor, a control electrode of the sixth transistor is in electrical connection with the first gate signal line, a first electrode of the sixth transistor is in electrical connection with the second initialization signal line, and a second electrode of the sixth transistor is in electrical connection with the third node; and
the light-emitting control sub-circuit comprises a fifth transistor, a control electrode of the fifth transistor is in electrical connection with the light-emitting control signal line, a first electrode of the fifth transistor is in electrical connection with the second node, and a second electrode of the fifth transistor is in electrical connection with the third node.

8. The pixel driving circuit according to claim 2, wherein the adjustment sub-circuit comprises a second capacitor;
a first end of the second capacitor is in electrical connection with the first initialization signal line, and a second end of the second capacitor is in electrical connection with the first node.

9. A display device, comprising:
a plurality of pixel units arranged in an array; and
a pixel driving circuit, configured to drive a light-emitting element to emit light across multiple frame cycles, each of the multiple frame cycles comprising at least a first frame in a timing sequence, and the pixel driving circuit comprising:
a source follower sub-circuit, in electrical connection with a fourth node, a power supply voltage line and a second node, configured to set a voltage at the second node equal to a voltage of the fourth node;
a driving sub-circuit, in electrical connection with a first node, the second node and a first gate signal line, configured to establish a conductive path between the first node and the second node under a control of a gate signal on the first gate signal line, so as to generate a current for driving the light-emitting element to emit light in the conductive path;
a data writing sub-circuit, in electrical connection with a second gate signal line, a data signal line, a reference signal line and the fourth node, configured to write a data signal on the data signal line to the fourth node under a control of a gate signal on the second gate signal line;
a compensation sub-circuit, in electrical connection with the first gate signal line, the reference signal line and the fourth node, and configured set the voltage at the fourth node equal to a reference signal on the reference signal line under the control of the gate signal on the first gate signal line;
a first reset sub-circuit, in electrical connection with a third gate signal line, a first initialization signal line and the first node, and configured to reset the first node through the initialization signal on the first initialization signal line under a control of a gate signal on the third gate signal line;
a second reset sub-circuit, in electrical connection with the first gate signal line, the second initialization signal line and an anode of the light-emitting element, and configured to reset the anode of the light-emitting element through the initialization signal on the second initialization signal line under the control of the gate signal on the first gate signal line; and
a light-emitting control sub-circuit, in electrical connection with a light-emitting control signal line and a third node, and configured to transmit the current for driving the light-emitting element emit light to the anode of the light-emitting element under a control of a light-emitting control signal on the light-emitting control signal line,
wherein the pixel driving circuit is in electrical connection with the plurality of pixel units and is configured to control the plurality of pixel units.

10. The display device according to claim 9, wherein each frame cycle comprises 2n frames in timing sequence, wherein n is an integer greater than or equal to 1, and the pixel driving circuit further comprises:
an adjustment sub-circuit which is in electrical connection with the first initialization signal line and the first node, configured to adjust a voltage at the first node to match the initialization signal on the first initialization signal line in frames other than the first frame in the 2n frames.

11. The display device according to claim 9, wherein the source follower sub-circuit comprises a source follower;
a control electrode of the source follower is in electrical connection with the fourth node, a first electrode of the source follower is in electrical connection with the power supply voltage line, and a second electrode of the source follower is in electrical connection with the second node.

12. The display device according to claim 9, wherein the driving sub-circuit comprises a drive transistor and a fourth transistor;
a control electrode of the drive transistor is in electrical connection with the first node, a first electrode of the drive transistor is in electrical connection with the second node, and a second electrode of the drive transistor is in electrical connection with a first electrode of the fourth transistor; and
a control electrode of the fourth transistor is in electrical connection with the first gate signal line, and a second electrode of the fourth transistor is in electrical connection with the first node.

13. The display device according to claim 9, wherein the data writing sub-circuit comprises a second transistor and a first capacitor;
a control electrode of the second transistor is in electrical connection with the second gate signal line, a first electrode of the second transistor is in electrical connection with the data signal line, and a second electrode of the second transistor is in electrical connection with the fourth node; and
a first end of the first capacitor is in electrical connection with the fourth node, and a second end of the first capacitor is in electrical connection with the reference signal line.

14. The display device according to claim 9, wherein the compensation sub-circuit comprises a first transistor;
a control electrode of the first transistor is in electrical connection with the first gate signal line, a first electrode of the first transistor is in electrical connection with the reference signal line, and a second electrode of the first transistor is in electrical connection with the fourth node.

15. The display device according to claim 9, wherein the first reset sub-circuit comprises a third transistor, a control electrode of the third transistor is in electrical connection with the third gate signal line a first electrode of the third transistor is in electrical connection with the first initialization signal line, and a second electrode of the third transistor is in electrical connection with the first node;
the second reset sub-circuit comprises a sixth transistor, a control electrode of the sixth transistor is in electrical connection with the first gate signal line, a first electrode of the sixth transistor is in electrical connection with the second initialization signal line, and a second electrode of the sixth transistor is in electrical connection with the third node; and
the light-emitting control sub-circuit comprises a fifth transistor, a control electrode of the fifth transistor is in electrical connection with the light-emitting control signal line, a first electrode of the fifth transistor is in electrical connection with the second node, and a second electrode of the fifth transistor is in electrical connection with the third node.

16. The display device according to claim 10, wherein the adjustment sub-circuit comprises a second capacitor;
a first end of the second capacitor is in electrical connection with the first initialization signal line, and a second end of the second capacitor is in electrical connection with the first node.

17. A control method for controlling a pixel driving circuit, wherein the pixel driving circuit is configured to drive a light-emitting element to emit light across multiple frame cycles, each of the multiple frame cycles comprises at least a first frame in a timing sequence, and the pixel driving circuit comprises:
a source follower sub-circuit which is in electrical connection with a fourth node, a power supply voltage line and a second node, and is configured to set a voltage at the second node equal to a voltage of the fourth node;
a driving sub-circuit which is in electrical connection with a first node, the second node and a first gate signal line, and is configured to establish a conductive path between the first node and the second node under a control of a gate signal on the first gate signal line, so as to generate a current for driving the light-emitting element to emit light in the conductive path;
a data writing sub-circuit which is in electrical connection with a second gate signal line, a data signal line, a reference signal line and the fourth node, and is configured to write a data signal on the data signal line to the fourth node under a control of a gate signal on the second gate signal line;
a compensation sub-circuit which is in electrical connection with the first gate signal line, the reference signal line and the fourth node, and is configured set the voltage at the fourth node equal to a reference signal on the reference signal line under the control of the gate signal on the first gate signal line;
a first reset sub-circuit, in electrical connection with a third gate signal line, a first initialization signal line and the first node, and configured to reset the first node through the initialization signal on the first initialization signal line under a control of a gate signal on the third gate signal line;
a second reset sub-circuit, which is in electrical connection with the first gate signal line, the second initialization signal line and an anode of the light-emitting element, and is configured to reset the anode of the light-emitting element through the initialization signal on the second initialization signal line under the control of the gate signal on the first gate signal line; and
a light-emitting control sub-circuit, which is in electrical connection with a light-emitting control signal line and a third node, and is configured to transmit the current for driving the light-emitting element emit light to the anode of the light-emitting element under a control of a light-emitting control signal on the light-emitting control signal line,
wherein the control method comprises:
displaying, within a single frame display cycle, one frame of image through a reset phase, a threshold compensation phase, a data writing phase and a light-emitting phase.
